(19) United States
(12) Patent Application Publication
(10) Pub. No.: US 2006/0208920 A1
(43) Pub. Date: Sep. 21, 2006

(54) Door stop beacon

(76) Inventor: Kenneth P. Carrella, New Rochelle, NY (US)

Correspondence Address: KAPLAN GILMAN GIBSON & DERNIER L.L.P., 900 ROUTE 9 NORTH, WOODBRIDGE, NJ, 07095, US

(21) Appl. No.: 11/079,563

(22) Filed: Mar. 14, 2005

(51) Int. Cl. G08B 21/00; G08B 3/00; G08B 23/00; G08B 5/00; G08G 1/095

(52) U.S. Cl. 340/686.1; 340/908; 340/815.4; 340/691.1; 340/693.5

(57) ABSTRACT

A door stop beacon comprises a door stop for preventing a door from moving and a lamp connected to the door stop for indicating the door. Preferably, the door stop is a wedge-shaped door chock with a slope upper surface. A switch is placed underneath the slope upper surface so that it can be automatically activated by a pressure applied to the upper surface when the door chock is inserted underneath the door. Alternatively, the switch can be manually activated by a button. Preferably, the lamp is accommodated in a housing having multiple transparent surfaces through which the light of the lamp can passes, so that the light can be visible from various directions. Preferably the lamp is capable of strobing or flashing.

### FIELD OF THE INVENTION

The present invention relates to a device for indicating the position of a door, and more particularly, to a door stop beacon which is capable of operating as both a door stop for preventing a door from moving and a beacon for indicating the position of the door.

### DESCRIPTION OF THE PRIOR ART

Door stops or door chocks are normally used by firefighters to prop open the entrance door to a structure or to keep open doors inside the building. Due to the thickness of the smoke in a building during a fire, the firemen often lose orientation and cannot locate the door.

In the prior art, audio alarm systems are incorporated in door chocks for signaling the position of a door. For example, U.S. Pat. No. 4,890,092 to Grimm discloses a door stop alarm that has a wedge-shaped housing in which is mounted a reciprocating elongated switch medially positioned biased through the upper face of the wedge. Upon depression of the wedge by a door opening, a circuit is completed at actuate and included alarm. A variety of frictional surfaces can be removably secured to an underlying surface of the housing.

Similarly, U.S. Pat. No. 5,008,648 to Conemac discloses an electronic door wedge alarm that is a wedge-shaped device for use as an alarm for detecting the unauthorized opening of a hinged, inwardly opening door. The device may be installed in the base of the door to resist forced opening of the door while simultaneously sounding a highly audible alarm signal indicative of an attempt to break in. The device uses a top chassis mounted on a bottom chassis to initiate that alarm whenever the top chassis is forced downwardly onto the bottom chassis. The alarm will continue to sound until the device is reset.

However, it is often uneasy for firemen to easily and precisely locate the door by the signaling sound alarm, especially in the noisy environment that typical occurs during a fire.

U.S. Pat. No. Des 309,708 to Rosa et al discloses a door stop that substantially has a wedge-shaped body with a frictional material connected to the top face. However, apparently no signaling system is shown in the '708 design patent.

### SUMMARY OF THE INVENTION

In view of the foregoing disadvantages inherent in the known types of door stops now present in the prior art, the present invention provides an improved door stop device, and overcomes the above-mentioned disadvantages and drawbacks of the prior art. As such, the general purpose of the present invention, which will be described subsequently in greater detail, is to provide a new and improved door stop device and method which has all the advantages of the prior art mentioned heretofore and many novel features that result in a door stop device which is not anticipated, rendered obvious, suggested, or even implied by the prior art, either alone or in any combination thereof.

It is therefore an object of the present invention to provide a new and improved door stop device that has all of the advantages of the prior art and none of the disadvantages.

It is another object of the present invention to provide a new and improved door stop device that is helpful to a user to effectively and precisely locate the door.

It is a further object of the present invention is to provide a door stop device for indicating the position of a door by light, preferably by a strobe or flashing light.

It is still another object of the present invention to provide a new and improved door stop device that may be easily and efficiently manufactured and marketed.

Still another object of the present invention is to provide a new door stop device that provides in the apparatuses and methods of the prior art some of the advantages thereof, while simultaneously overcoming some of the disadvantages normally associated therewith.

To attain this, the present invention discloses a door stop beacon which essentially comprises a door stop for preventing a door from moving and a lamp secured to said door stop for indicating the location of the door. Thus, the position of the door can be conveniently and precisely located by the lamp.

Preferably, the door stop is a wedge-shaped door chock having an upper slope surface, a vertical surface and a bottom surface. Preferably a switch is located under the upper slope surface for automatically turning on the lamp upon a pressure applied to the upper slope surface when the door chock is inserted under the door to keep it open. Preferably the upper surface comprises a friction pad. Alternatively to the above pressure activation, the device may have an on/off switch or button for manual activation.

There has thus been outlined, rather broadly, the more important features of the invention in order that the detailed description thereof that follows may be better understood and in order that the present contribution to the art may be better appreciated.

### BRIEF DESCRIPTION OF THE DRAWINGS

The above and other objects, features and advantages of the present invention will be readily apparent to those of ordinary skill in the art upon a reading of the following detailed description of presently preferred, but nonetheless illustrative, embodiments of the present invention when taken in conjunction with the accompanying drawings, in which:

FIG. 1 is a top perspective view of an embodiment of the door stop beacon in accordance with the principles of the present invention;

FIG. 2 is a top plan view of the door stop beacon of the embodiment as shown in FIG. 1;

FIG. 3 is a sectional view taken along line 3-3 in FIG. 2;

FIG. 4 is a perspective view of another embodiment of the door stop beacon in accordance with the principles of the present invention;

FIG. 5 is a side elevational view of the embodiment shown in FIG. 4;

FIG. 5a is an partial view showing the lamps and its electrical circuit; and

FIGS. 6a and 6b illustrates the exemplary textures of the top and bottom surfaces of the embodiment shown in FIGS. 4 and 5.

### DESCRIPTION OF THE PREFERRED EMBODIMENT

In the embodiments, same reference numerals refer to the similar elements throughout the drawings.

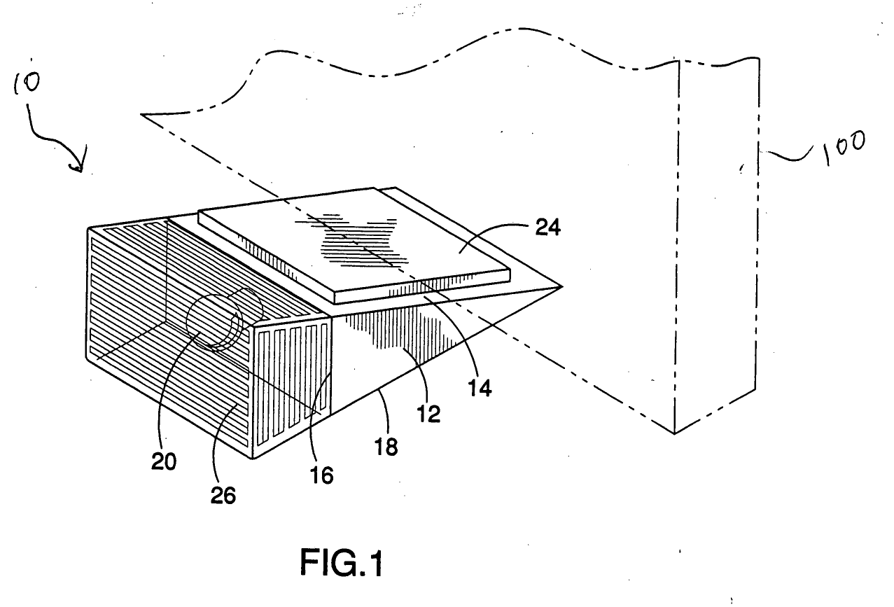

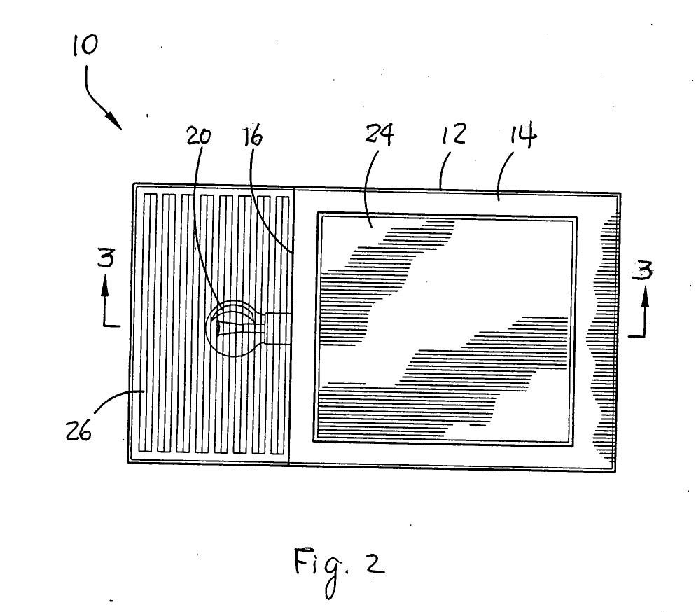

Referring now to FIGS. 1-3, in which a first embodiment of the door stop beacon of the present invention is shown and generally designated by the reference numeral 10.

The door stop beacon 10 comprises a wedge-shaped door stop or chock 12, which, when being inserted underneath a door 100, prevents the door 100 from moving. For example, during a fire, a fireman can insert the door chock 12 underneath an entrance door of a building on fire to keep the door open. The device can also be used under any interior door for the same purpose. The wedge-shaped housing 12 can be of any proper size. For example, it can be 4 inches long, 2 inches high and 1 inches wide.

In this embodiment, the door chock 12 is a right triangular wedge. The door chock 12 has a slope or hypotenuse surface 14, a vertical surface 16 and a bottom surface 18. A friction pad 24 may be mounted on the slope surface 14 for firmly keeping the door 100 in place.

According to the teaching of the present invention, the door stop beacon 10 further comprises a lamp 20 which is secured to the door chock 12. In this embodiment as shown in FIGS. 1-3, the lamp 20 is connected to the vertical surface 16 of the door chock 12. Preferably, the door stop beacon 10 further comprises a housing 26 for enclosing the lamp 20 therein and deflecting the light from the lamp 20.

Some or all of various surfaces of the housing 26 are made of a material that permits light from the lamp 20 to pass through. In this embodiment, all of the surfaces of the housing 26 are made of lenses. The lenses can be of any proper pattern. The light from the lamp 20 can be seen from various directions.

Alternatively, only some of the surfaces or some portions of the surfaces are made of lenses or other transparent material. Preferably, the lamp 20 or these transparent portions or surfaces can be clear, but are preferably colored, e.g., in red or amber.

Preferably, the lamp 20 is capable of flashing or strobing.

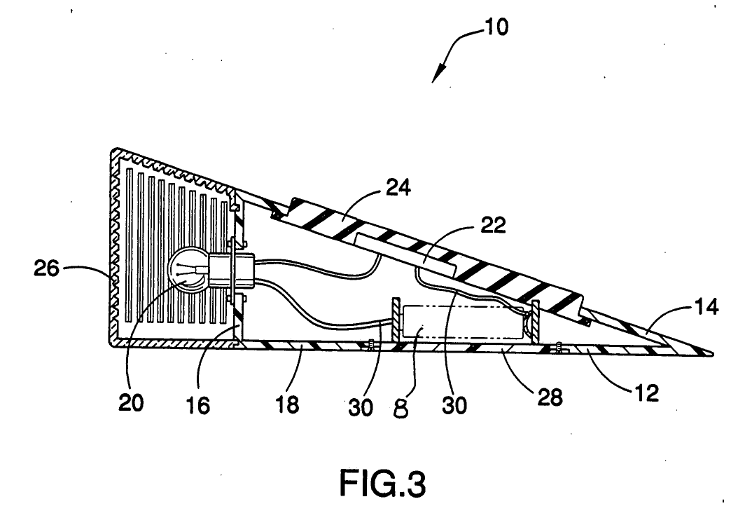

As illustrated in FIG. 3, the electrical circuit of the lamp 20 is accommodated inside the door chock 12. The electrical circuit comprises a pressure switch 22 for turning the lamp 20 on and off. Preferably, the pressure switch 22 is located underneath the slope or hypotenuse surface 14. When a force is applied on the slope surface 14 or the friction pad 24, the switch 22 is activated to turn on the lamp 20. Thus, when the door chock 12 is inserted underneath the door 100, as illustrated in FIG. 1, the switch 22 is automatically activated. The lamp 20 is preferably powered by one or more batteries 8 installed inside the door chock 12. A battery chamber door 28 is provided on the bottom surface 18 for getting access to the batteries 8. The lamp 20, batteries 8 and the switch 22 are connected by wires 30 to form the electrical circuit.

In use, it can now be understood that the door stop beacon 10 is placed under a door as a normal door chock which depresses the pressure switch 22 which energizes the lamp 20 to provide guidance for the location of the door, as for example, by strobing.

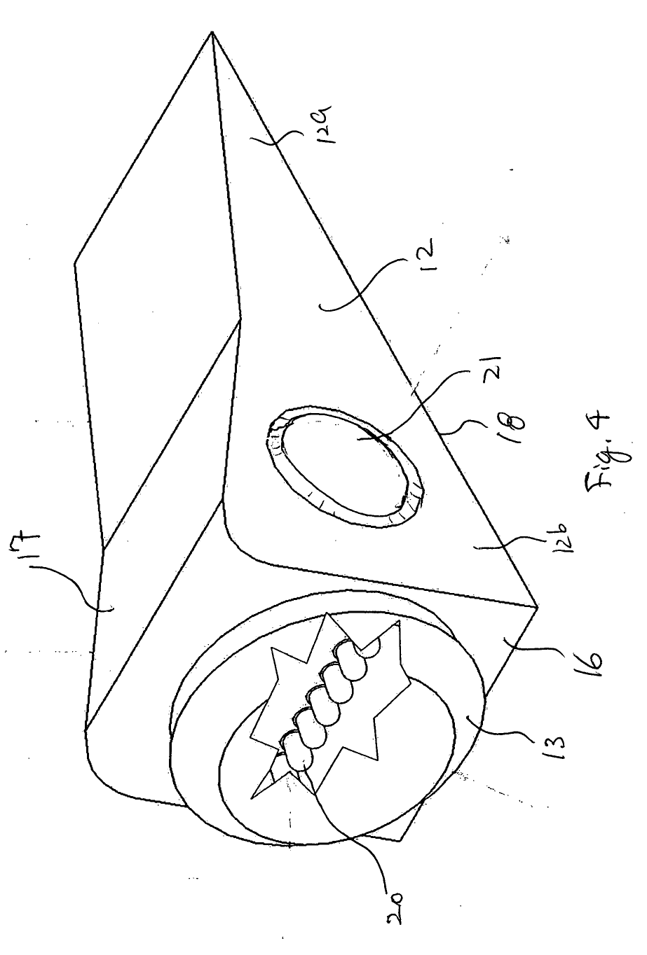

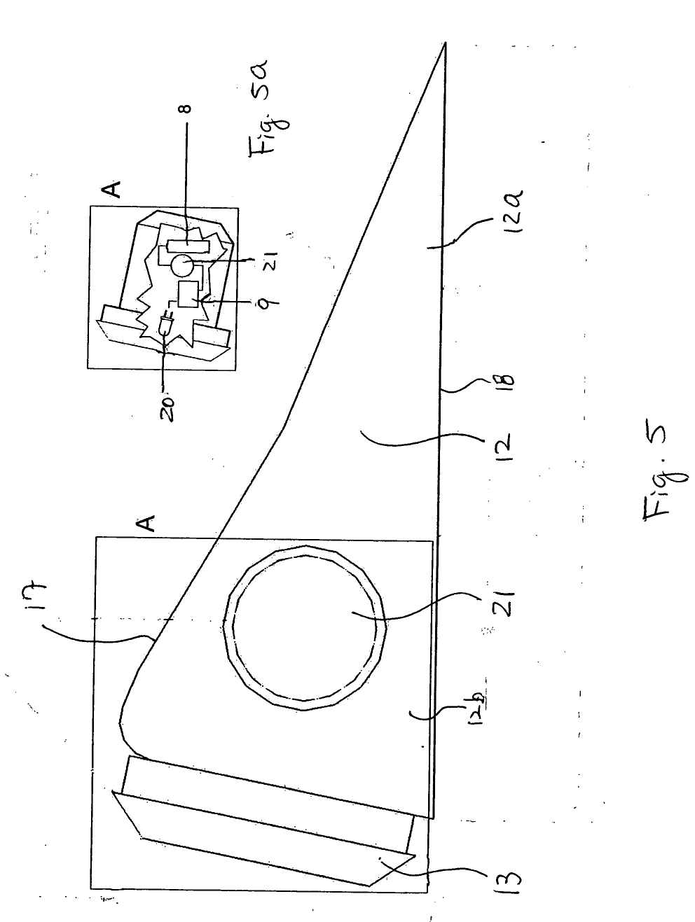

FIGS. 4 and 5 illustrate another embodiment of the door stop beacon 10 according the present invention. In this embodiment, the door stop beacon 10 comprises a door chock 12 formed by a front portion 12a and a rear portion 12b.

Similar to the embodiment in FIGS. 1-3, the front portion 12a is wedge-shaped and suitable to be inserted underneath a door 100 to prevent the door 100 from moving. This portion may have a friction pad 24 as in the previous embodiment shown in FIGS. 1-3.

The rear portion 12b forms a housing for accommodating a plurality of lamps 20, the light of which emits from a transparent cap 13 mounted on the back surface 16 of the door chock 12. The lamps 20 preferably protrude beyond the back surface 16 so that the light can be visible from different directions. Preferably, the lamps 20 are a LED array.

The lamps 20 are manually switched on/off by pressing a button 21 provided on a side surface of the door chock 12. As further illustrated in FIG. 5a, the lamps 20 are mounted on a circuit board 9, which is powered by a battery 8 controlled by the switch button 21. The whole electric circuit of the lamps 20 is accommodated in the housing formed by the rear portion 12b of the door chock 12.

The lamps 20 are capable of strobing, and may be colored. Alternatively, the cap 13 is colored, such as in red or amber.

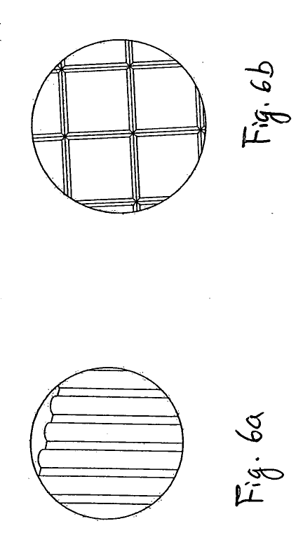

Preferably, to help the door chock 12 stay in place, the top surface 17 of the rear portion 12b has a corrugated surface as shown in FIG. 6a, while the bottom surface 18 has a texture of grid pattern as shown in FIG. 6b.

While preferred embodiments of the door stop beacon have been described in detail, it should be apparent that numerous modifications, adaptations and variations thereto are possible to a person skilled in the art without departing from the spirit of the present invention. For example, the door stop does not have to be a wedge-shaped chock. Alternatively, it can be a block of any proper shape and made of a heavy material such as a metal. Thus, the door is prevented from moving by the means of the weight of the door stop. Therefore, the scope of the present invention is intended to be solely defined by the claims.

What is claimed is:

1. A door stop beacon comprising a door stop for preventing a door from moving, and a lamp secured to said door stop.

2. The door stop beacon of claim 1, further comprising a switch electrically connected to said lamp for turning on and off said lamp.

3. The door stop beacon of claim 2, wherein said switch is manually activatable by a switch button provided on an outer surface of said door stop.

4. The door stop beacon of claim 2, wherein said switch is automatically activatable when said door stop is in its operation position.

5. The door stop beacon of claim 2, wherein said lamp is powered by one or more batteries.

6. The door stop beacon of claim 1, wherein said door stop is a wedge-shaped door chock having a hypotenuse surface, a vertical surface and a bottom surface.

7. The door stop beacon of claim 6, further comprising a switch electrically connected to said lamp for turning on and off said lamp, said switch being located under said hypotenuse surface and is activatable to turn on said lamp under a pressure applied on said hypotenuse surface.

8. The door stop beacon of claim 7, wherein said pressure is applied when said door chock is inserted underneath said door.

9. The door stop beacon of claim 8, further comprising a friction pad mounted on said hypotenuse surface.

10. The door stop beacon of claim 6, wherein said lamp is connected to said vertical surface.

11. The door stop beacon of claim 10, wherein said lamp is accommodated in a housing.

12. The door stop beacon of claim 10, wherein surfaces of said housing comprise transparent lenses.

13. The door stop beacon of claim 11, wherein said lamp or said lenses are colored.

14. The door stop beacon of claim 11, wherein said housing is an extension of said door chock extending from said vertical surface.

15. The door stop beacon of claim 1, wherein said lamp is capable of strobing.

16. A door stop comprising body portion adapted to prevent a door from moving, and a lamp connected to said body portion.

17. The door stop of claim 16, wherein light of said lamp is visible from multiple directions.

18. The door stop of claim 17, wherein said door stop further comprises a housing for accommodating said lamp therein, said housing having multiple transparent surfaces through which said light is visible.

19. The door stop of claim 18, wherein said housing is an extension from a back surface of said body portion.

20. The door stop of claim 18, wherein said housing is formed by a cap mounted on said back surface.

21. The door stop of claim 18, wherein said lamp or said transparent surfaces are colored.

22. The door stop of claim 16, wherein said lamp is capable of flashing.

23. A strobe comprising a lamp secured to a body portion for signaling its position, wherein said body portion is adapted to operate as a door stop for preventing a door from moving.

24. The strobe of claim 23, wherein said body portion is wedge-shaped, with an upper slope surface, a front vertical surface opposite to said upper sloping surface and a bottom surface.

25. The strobe of claim 25, further comprising a switch for turning on and off said lamp, said switch being located under said upper slope surface whereby it is automatically activatable by a pressure applied on said upper slope surface when said body portion is inserted underneath said door.

26. The strobe of claim 24, further comprising a housing formed on said body portion for accommodating said lamp, said housing having multiple transparent surfaces in various directions through which light of said lamp is capable of passing.

27. The strobe of claim 26, wherein said lamp or said transparent surfaces are colored.
